(19) United States
(12) Patent Application Publication
(10) Pub. No.: US 2026/0295607 A1
(43) Pub. Date: Oct. 1, 2026

(54) CIRCULATING SWITCHABLE SHOWER HEAD, FAUCET, AND SHOWER SYSTEM

(71) Applicant: Zhangzhou Solex Smart Home Co., Ltd., Zhangzhou City (CN)

(72) Inventors: Jianhong Yang, Zhangzhou City (CN); Zhida Chen, Zhangzhou City (CN); Lucheng Wang, Zhangzhou City (CN); Wenxing Chen, Zhangzhou City (CN)

(21) Appl. No.: 19/572,445

(22) Filed: Mar. 19, 2026

(30) Foreign Application Priority Data
Mar. 27, 2025 (CN) 202510376452.8

(51) Int. Cl. B05B 1/16

(52) U.S. Cl. CPC B05B 1/1618

(57) ABSTRACT

A circulating switchable shower head includes a water channel body, a water channel switching mechanism, and an upstream switching mechanism. The water channel body has a first water channel and second water channels. The water channel switching mechanism has a water distribution member. A water distribution port on the water distribution member is alternatively in communication with an inlet port of a selected one of the second water channels. The upstream switching mechanism includes an upstream switching body and a switching assembly. The upstream switching body has a water inlet, a first upstream outlet port, and a second upstream outlet port. The switching assembly has a first state causing water flow to pass through the first upstream outlet port or a second state causing the water flow to pass through the second upstream outlet, and can maintain the first state due to water pressure, switching to the second state upon loss of the water pressure.

### RELATED APPLICATIONS

This application claims priority to Chinese patent application number 202510376452.8, filed on Mar. 27, 2025. Chinese patent application number 202510376452.8 is incorporated herein by reference.

### FIELD OF THE DISCLOSURE

The present disclosure relates to the technical field of shower heads, and in particular to a circulating switchable shower head, a faucet, and a shower system.

### BACKGROUND OF THE DISCLOSURE

A shower head is a commonly used kitchen or bathroom accessory. Existing shower heads have multiple water outlet modes to meet people's daily needs, and suitable water outlet modes can be selected according to personal preferences and habits during use. However, the water outlet mode of the shower head in the prior art at the initial startup remains in the state from the last time the water was turned off, which is also random and lacks a fixed default water outlet mode. This results in the possibility of water splashing at the initial startup if it remains in a stronger water outlet state, affecting the user experience.

### BRIEF SUMMARY OF THE DISCLOSURE

The purpose of the present disclosure is to provide a circulating switchable shower head, a faucet, and a shower system, which can ensure a fixed water outlet mode at an initial use.

In order to solve the above technical problems, the present disclosure provides a circulating switchable shower head, comprising a water channel body, a water channel switching mechanism, and an upstream switching mechanism. The water channel body has a first water channel and a plurality of second water channels, and the water channel switching mechanism comprises a control assembly and a water distribution member. The water distribution member comprises a water distribution port, and the water distribution member is disposed on the water channel body. The control assembly is configured to drive the water distribution member to switch relative to the water channel body, so that the water distribution port is alternatively in communication with an inlet port of a selected one of the plurality of second water channels, and the upstream switching mechanism comprises an upstream body and a switching assembly. The upstream body has a water inlet port as well as a first upstream outlet port and a second upstream outlet port which are in communication with the water inlet, and the first upstream outlet port is in communication with the water distribution port. The second upstream outlet port is in communication with an inlet port of the first water channel, and the switching assembly is disposed on the upstream body. The switching assembly has a first state in which a water flow is enabled to pass through the first upstream outlet port and a second state in which the water flow is enabled to pass through the second upstream outlet. After the switching assembly is switched to the first state, the switching assembly is configured to be maintained in the first state due to water pressure. When the water pressure is lost, the switching assembly is switched from the first state to the second state.

In some embodiments, the switching assembly comprises an upstream control button, and the upstream control button is configured to control the switching assembly to be switched from the second state to the first state.

In some embodiments, the circulating switchable shower head comprises a linkage mechanism, and the linkage mechanism is connected to the switching assembly and the control assembly. When the control assembly drives the water distribution member to switch, the linkage mechanism is configured to drive the switching assembly to be switched from the second state to the first state.

In some embodiments, the control assembly is configured to drive the water distribution member to be switched unidirectionally or bidirectionally in sequence relative to the water channel body, so that the water distribution port is alternatively in communication with the inlet port of the selected one of the plurality of second water channels in a unidirectional or bidirectional sequence.

In some embodiments, the water channel body is provided with a water distribution chamber, and the water distribution chamber has a chamber inlet. The first upstream outlet port is in communication with the water distribution chamber, and inlet ports of the plurality of second water channels are distributed circumferentially within the water distribution chamber. The water distribution member is rotatably disposed in the water distribution chamber, and the control assembly is configured to drive the water distribution member to rotate bidirectionally in the water distribution chamber.

In some embodiments, one or more water distribution sealing rings are arranged around peripheries of the inlet ports of the plurality of second water channels, and the water distribution member abuts the one or more water distribution sealing rings.

In some embodiments, a first elastic member is further disposed in the water distribution chamber, and the first elastic member is located on a side of the water distribution member away from the one or more water distribution sealing rings. The first elastic member is configured to enable the water distribution member to have a tendency to press the one or more water distribution sealing rings.

In some embodiments, the control assembly comprises a ratchet wheel, a pawl member, and a water channel control button, and the pawl member is pivotally connected to the water channel body. The ratchet wheel is connected to the water distribution member through a first rotating shaft and pivotally connected to the water channel body.

In some embodiments, the ratchet wheel has first ratchet teeth and second ratchet teeth, and the first ratchet teeth and the second ratchet teeth are oriented in opposite directions. The pawl member has two pawls opposing to each other, and the two pawls respectively engage with the first ratchet teeth and the second ratchet teeth. The water channel control button is connected to the pawl member, and a force is configured to be applied to the water channel control button to enable one of the two pawls to be separated from the ratchet wheel while a second one of the two pawls pushes the ratchet wheel to rotate. A second elastic member is further disposed between the pawl member and the water channel body to reset the pawl member.

In some embodiments, magnetic members are arranged on the two pawls and the water channel body. When the magnetic members on the two pawls face the magnetic members on the water channel body, the two pawls engage with the ratchet wheel.

In some embodiments, a partition wall is arranged circumferentially along an outer periphery of the ratchet wheel, and the first ratchet teeth and the second ratchet teeth are located on two sides of the partition wall.

In some embodiments, the upstream body comprises a switching chamber, and the water inlet, the first upstream outlet, and the second upstream outlet port are all in communication with the switching chamber. The switching chamber has a switching port, and the switching assembly comprises a switching shaft and a third elastic member. A blocking member is disposed on the switching shaft, and the third elastic member is disposed in the switching chamber. A first end of the switching shaft is connected to the third elastic member. In the first state, the blocking member blocks the second upstream outlet, and in the second state, the blocking member blocks the first upstream outlet. The third elastic member is configured to enable the switching assembly to have a tendency to be maintained in the first state.

In some embodiments, the linkage mechanism comprises a linkage body, and a first end of the linkage body is connected to the pawl member. A second rotating shaft is disposed between the first end and a second end of the linkage body, and the linkage body is pivotally connected to the upstream body or the water channel body through the second rotating shaft. The second end of the linkage body is located above the switching port, and a surface of the second end of the linkage body facing the switching port is provided with a low point and a high point. In the second state, the switching shaft abuts the low point, and the linkage body is configured to be rotated to drive the switching shaft to be switched to the low point or the high point.

In some embodiments, the pawl member is provided with a swing groove, and the first end of the linkage body is provided with a swing shaft. The swing shaft is disposed in the swing groove, so that a groove wall of the swing groove abuts and drives the swing shaft to enable the linkage body to rotate.

In some embodiments, the surface of the second end of the linkage body facing the switching port has an abutting groove, and a bottom of the abutting groove defines the low point. An outer side of the abutting groove is defined as the high point.

In some embodiments, a size of the abutting groove gradually increases from the bottom of the abutting groove to an opening of the abutting groove.

In some embodiments, the water channel control button is a pressing button or a pushing button.

The present disclosure provides a faucet comprising the circulating switchable shower head.

The present disclosure provides a shower system comprising the circulating switchable shower head.

The technical solution has the following advantages.

The aforementioned circulating switchable shower head has the first water channel and the plurality of second water channels provided in the water channel body. The switching assembly on the upstream switching mechanism allows the water flow to alternatively pass through one of the first upstream outlet port or the second upstream outlet. In the second state, the switching assembly enables the water flow to flow through the second upstream outlet port to exit directly from the first water channel. When the switching assembly is switched to the first state, the water flow enters the water distribution port through the first upstream outlet port and then exits from one of the plurality of second water channels, allowing for selection of different water outlet modes. Furthermore, due to the water pressure, the switching assembly is maintained in the first state. After turning off the water flow, as the water pressure disappears, the switching assembly is switched from the first state back to the second state, returning to an initial water outlet state where the water flow can flow from the second upstream outlet port to the first water channel. Upon next use, the switching assembly remains in this state (i.e., the initial water outlet state). Thus, the aforementioned circulating switchable shower head ensures a fixed initial water outlet mode, enhancing a user experience.

### BRIEF DESCRIPTION OF THE DRAWINGS

FIG. 1 is a schematic diagram of the circulating switchable shower head of the present disclosure.

FIG. 2 is a schematic diagram of the circulating switchable shower head of the present disclosure with a housing removed.

FIG. 3 is an exploded view of the circulating switchable shower head of the present disclosure.

FIG. 4 is a schematic diagram of a water channel body in the present disclosure

FIG. 5 is a path diagram of water entering a first water channel through a second upstream outlet port in the present disclosure.

FIG. 6 is an enlarged view of section A in FIG. 5.

FIG. 7 is a path diagram of the water entering a water distribution port through a first upstream outlet port in the present disclosure.

FIG. 8 is a partial cross-sectional view showing a control assembly in the present disclosure.

FIG. 9 is a path diagram of the water entering a water distribution chamber in the present disclosure.

FIG. 10 is a partial cross-sectional view of a second elastic member in the control assembly of the present disclosure.

FIG. 11 is a schematic diagram of a cooperation between a ratchet wheel and a pawl member in the present disclosure.

FIG. 12 is a schematic diagram showing magnetic members in the present disclosure.

FIG. 13 is a schematic diagram of a linkage body in the present disclosure.

FIG. 14 is a state diagram of the control assembly and a linkage mechanism when switching a water distribution member in one direction in the present disclosure.

FIG. 15 is a state diagram of the control assembly and the linkage mechanism when switching the water distribution member in a second direction in the present disclosure.

FIG. 16 is a schematic diagram of another form of a water channel control button in the present disclosure.

FIG. 17 is a schematic diagram of a faucet in the present disclosure.

In the drawings:
100. Circulating switchable shower head;
1. Water channel body; 11. First water channel; 12. Second water channel; 13. Water distribution chamber; 131. Chamber inlet port; 14. Protruding platform;
2. Water channel switching mechanism; 21. Control assembly; 211. Ratchet wheel; 2111. First ratchet teeth; 2112. Second ratchet teeth; 2113. Partition wall; 212. Pawl member; 2121. Pawl; 2122. Swing groove; 213. Water channel control button; 214. Second elastic member; 215. Magnetic member; 216. First rotating shaft; 217. Connecting rod 22. Water distribution member; 221. Water distribution port; 222. First groove; 223. Second groove; 23. Water distribution sealing ring; 24. First elastic member;
3. Upstream switching mechanism; 31. Upstream body; 311. Switching chamber; 3111. Switching port; 3112. Inclined wall; 312. Water inlet port; 313. First upstream outlet port; 314. Second upstream outlet port; 32. Switching assembly; 321. Switching shaft; 322. Third elastic member; 323. Blocking member; 324. Switching sealing ring;
4. Linkage mechanism; 41. Linkage body; 411. Abutting groove; 412. Swing shaft; 42. Second rotating shaft; 43. Position-limiting plate;
5. Water inlet joint; 51. Flow-increasing member;
6. Housing.

### DETAILED DESCRIPTION OF THE EMBODIMENTS

The following describes the present disclosure in further detail in conjunction with the accompanying drawings and embodiments. It is to be understood that the specific embodiments described herein are merely illustrative of the present disclosure and are not intended to limit it. Furthermore, it should be noted that, for ease of description, the drawings only show parts related to the present disclosure and not the entire structure.

In the description of the present disclosure, unless otherwise explicitly specified and defined, the terms “connected”, “connected to”, and “fixed” should be understood broadly. For example, the terms “connected” and “connected to” may refer to a fixed connection, a detachable connection, or an integral connection; they may be a mechanical connection or an electrical connection; they may be a direct connection or an indirect connection through an intermediary; they may refer to the internal communication between two elements or the interactive relationship between two elements. For those of ordinary skill in the art, the specific meanings of the above terms in the present disclosure can be understood based on the specific context.

In the present disclosure, unless otherwise explicitly specified and defined, a first feature being “above” or “below” a second feature may include direct contact between the first and second features, or may include that the first and second features are not in direct contact but are in contact through additional features between them. Furthermore, the first feature being “on”, “above”, or “over” the second feature includes the first feature being directly above or obliquely above the second feature, or may merely indicate that the horizontal level of the first feature is higher than that of the second feature. The first feature being “under”, “below”, or “beneath” the second feature includes the first feature being directly below or obliquely below the second feature, or may merely indicate that the horizontal level of the first feature is lower than that of the second feature.

In the description of this embodiment, directional or positional relationships indicated by terms such as “upper”, “lower”, “left”, and “right” are based on the orientations or positional relationships shown in the accompanying drawings. They are used merely for ease of description and simplification of operation, and do not indicate or imply that the referred device or element must have a specific orientation or be constructed and operated in a specific orientation. Therefore, they should not be construed as limiting the present disclosure. Furthermore, the terms “first” and “second” are used merely for descriptive differentiation and have no special meaning.

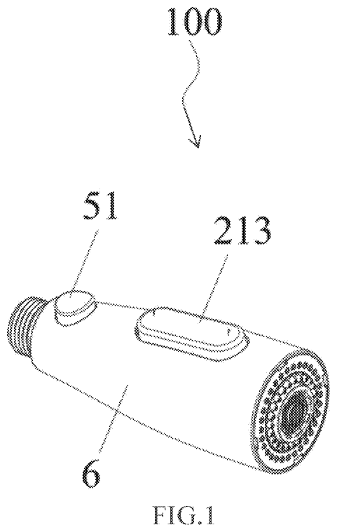

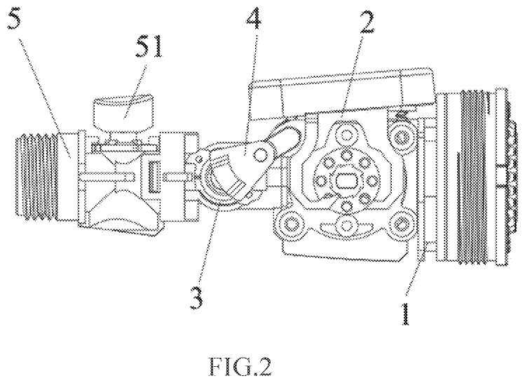

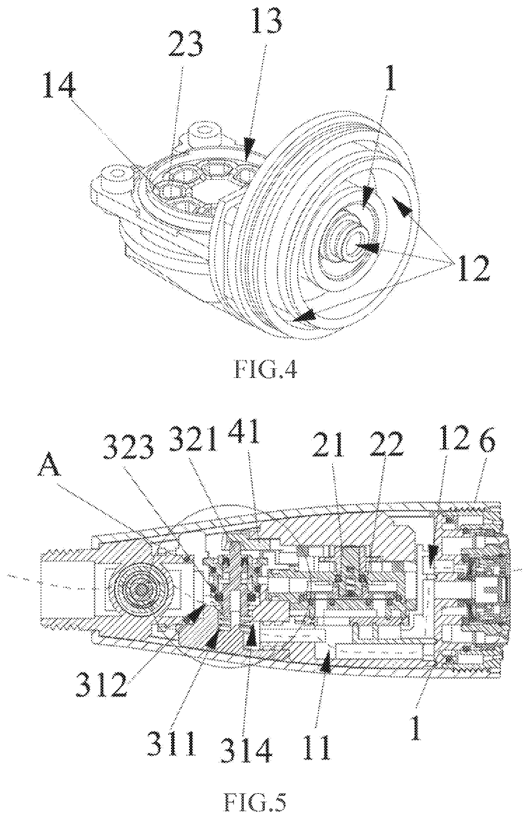

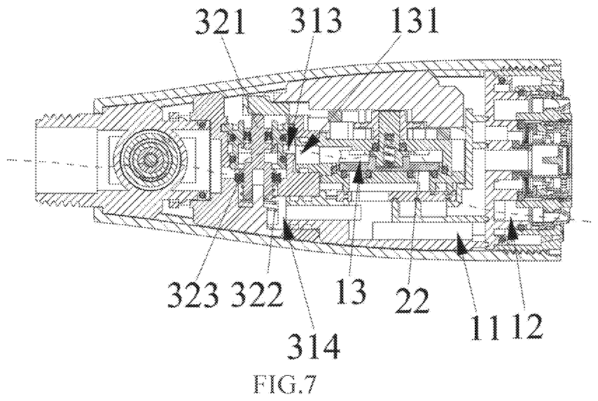

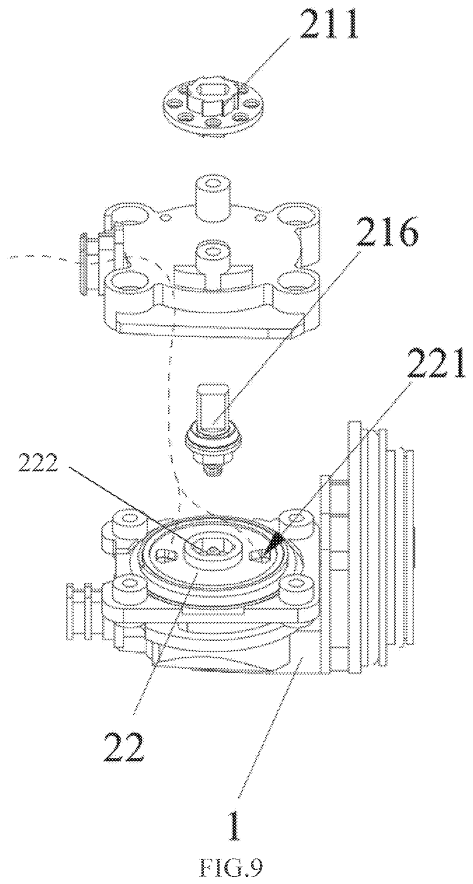

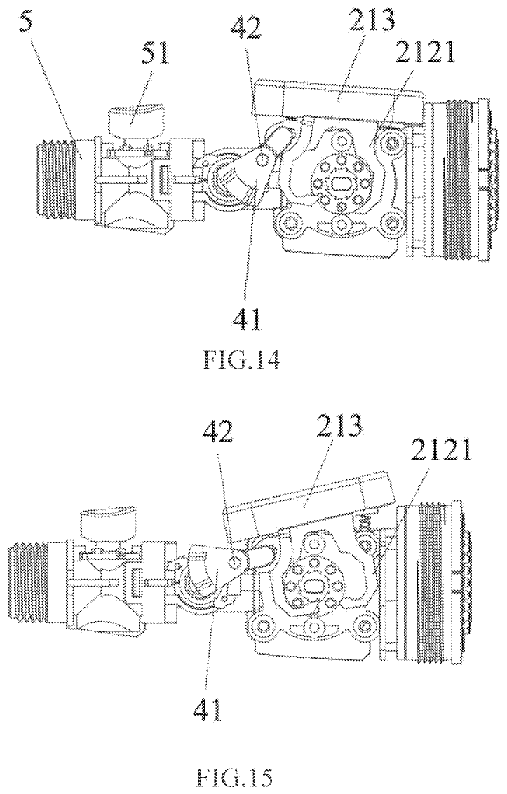

As shown in FIGS. 1 to 16, the present application provides a circulating switchable shower head 100. The circulating switchable shower head 100 comprises a water channel body 1, a water channel switching mechanism 2, and an upstream switching mechanism 3. The water channel body 1 has a first water channel 11 and a plurality of second water channels 12. The water channel switching mechanism 2 is provided with a control assembly 21 and a water distribution member 22. The water distribution member 22 is provided with a water distribution port 221. The water distribution member 22 is disposed on the water channel body 1. The control assembly 21 drives the water distribution member 22 to switch relative to the water channel body 1, so that the water distribution port 221 is switched to be in communication with an inlet port of a selected one of the plurality of second water channels 12. The upstream switching mechanism 3 comprises an upstream body 31 and a switching assembly 32. The upstream body 31 has a water inlet port 312, as well as a first upstream outlet port 313 and a second upstream outlet port 314, which are in communication with the water inlet port 312. The first upstream outlet port 313 is in communication with the water distribution port 221, and the second upstream outlet port 314 is in communication with an inlet port of the first water channel 11. The switching assembly 32 is disposed on the upstream body 31. The switching assembly 32 has a first state in which a water flow is enabled to pass through the first upstream outlet port 313 or a second state in which the water flow is enabled to pass through the second upstream outlet port 314. After the switching assembly 32 is switched to be in the first state, the switching assembly 32 can be maintained in the first state due to water pressure. When the water pressure is lost, the switching assembly 32 is switched from the first state to the second state.

The circulating switchable shower head 100 has the water distribution member 22 and the plurality of second water channels 12 on the water channel body 1. Based on this, each of the plurality of second water channels 12 can be disposed with different water outlet components, thereby forming different water outlet modes. The water channel body 1 is further provided with the first water channel 11, and the first water channel 11 can also receive different water outlet components. The switching assembly 32 on the upstream switching mechanism 3 enables the water flow to alternatively pass through one of the first upstream outlet port 313 or the second upstream outlet port 314. In the second state, the switching assembly 32 enables the water flow to directly flow out of the first water channel 11 after passing through the second upstream outlet port 314. This state can be set as a default initial water outlet state. When the switching assembly 32 is switched to be in the first state, the water flow flows through the first upstream outlet port 313 into the water distribution port 221, and then is discharged from the selected one of the plurality of second water channels 12. At this point, the different water outlet modes can be selected, and the switching assembly 32 is maintained in the first state due to the water pressure. After turning off the water flow, due to the water pressure being lost, the switching assembly 32 is switched from the first state to the second state, returning to the default initial water outlet state in which the water flow can flow through the second upstream outlet port 314 to the first water channel 11. When used again, the switching assembly 32 is maintained in this state. Therefore, the aforementioned circulating switchable shower head 100 can ensure a fixed water outlet mode at the start of use, enhancing a user experience.

The circulating switchable showerhead 100 has a housing 6. The housing 6 has an inner cavity. The water channel body 1, the water distribution member 22, and the upstream body 31 are located within the inner cavity of the housing 6. In the current embodiment, the water distribution member 22 adopts a water distribution disc.

It should be noted here that a number of the plurality of second water channels 12 is not specifically limited. In the current embodiment, three second water channels 12 are provided, and each of the three second water channels 12 is equipped with the different water outlet components, such as components capable of producing soft mist water, components capable of producing blade-shaped water, components capable of producing converging water, etc., thereby forming the different water outlet modes according to the different water outlet components. The first water channel 11 is disposed with a component that generates bubble water. In some alternative embodiments, four second water channels 12 are provided, and each of the four second water channels 12 is equipped with the aforementioned water outlet components. An outlet port of the first water channel 11 is connected to one of the plurality of second water channels 12, and a connecting junction of the outlet port of the first water channel 11 and the one of the plurality of second water channels 12 is located between the inlet port and an outlet port of the one of the plurality of second water channels 12. This means the water flow from the first water channel 11 flows out through the one of the plurality of second water channels 12, thus covering all water outlet forms during water path switching.

In some embodiments, the control assembly 21 can drive the water distribution member 22 to be switched to change unidirectionally or bidirectionally in sequence, causing the water distribution member 22 to rotate unidirectionally or bidirectionally. Therefore, the water distribution port 221 can be switched to be in communication with the selected one of the plurality of second water channels unidirectionally or bidirectionally. Bidirectional switching can avoid a path becoming longer when using unidirectional switching (i.e., bidirectional switching allows switching in a forward order or a reverse order, enabling direct access to a previous position or a next position). This is especially beneficial in systems with three or more water channels. For example, with unidirectional switching (e.g., 1→2→3→4→1→2→3 . . . ), moving from channel 1 to 4 requires passing through intermediate channels 2 and 3. In contrast, bidirectional switching supports sequences like 1→4→3→2→1→4→3 . . . , allowing direct shifts from channel 1 to 4 without unnecessary intermediate steps. This reduces switching actions and improves efficiency.

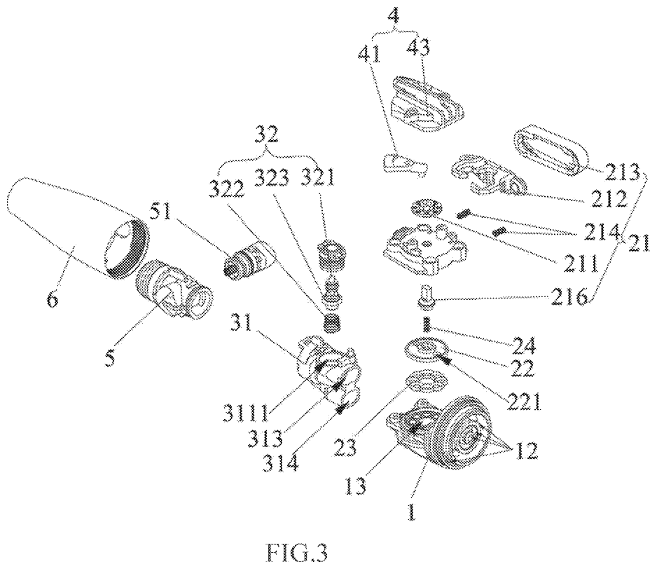

As shown in FIGS. 3, 4, and 7, in some embodiments, the water channel body 1 is provided with a water distribution chamber 13. The water distribution chamber 13 has a chamber inlet port 131, and the chamber inlet port 131 is in communication with the first upstream outlet port 313, enabling the water flow to enter the water distribution chamber 13 through the first upstream outlet port 313. The inlet ports of the plurality of second water channels 12 are distributed circumferentially within the water distribution chamber 13. The water distribution member 22 is rotatably disposed in the water distribution chamber 13, and the control assembly 21 is connected to the water distribution member 22. Thus, during water channel switching, the control assembly 21 drives the water distribution member 22 to rotate, enabling the water distribution port 221 on the water distribution member 22 to correspond to a selected one of the inlet ports of the plurality of second water channels 12 circumferentially distributed.

In some embodiments, the water channel body 1 can be integrally formed with the upstream body 31, thereby connecting the chamber inlet port 131 to the first upstream outlet port 313, and connecting the second upstream outlet port 314 to the inlet port of the first water channel 11.

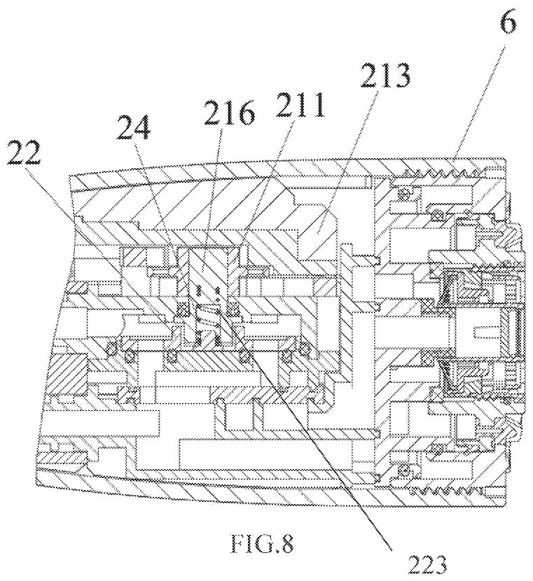

Specifically, as shown in FIGS. 8 to 11, the control assembly 21 comprises a ratchet wheel 211, a pawl member 212, a first rotating shaft 216, and a water channel control button 213. A through-hole is provided on the water distribution chamber 13. The first rotating shaft 216 is disposed in the water distribution chamber 13. One end of the first rotating shaft 216 is connected to the water distribution member 22, and a second end of the first rotating shaft 216 is sealed to and passes through the through-hole to be connected to the ratchet wheel 211. Thus, a bidirectional rotation of the ratchet wheel 211 drives a bidirectional rotation of the water distribution member 22. In the current embodiment, the ratchet wheel 211 is provided with first ratchet teeth 2111 and second ratchet teeth 2112. Each of the first ratchet teeth 2111 and the second ratchet teeth 2112 is distributed circumferentially on an outer peripheral surface of the ratchet wheel 211, and a tooth direction of the first ratchet teeth 2111 and a tooth direction of the second ratchet teeth 2112 are oriented in opposite directions. The pawl member 212 is pivotally connected to the water channel body 1. The pawl member 212 has two pawls 2121 on opposing sides of the first ratchet teeth 2111 and the second ratchet teeth 2112, and the two pawls 2121 can respectively engage with the first ratchet teeth 2111 and the second ratchet teeth 2112. The water channel control button 213 is connected to the pawl member 212. Therefore, when a force is applied to the water channel control button 213, the pawl member 212 is rotated relative to the water channel body 1, causing one of the two pawls 2121 to disengage from the ratchet wheel 211, while a second one of the two pawls 2121 pushes the ratchet wheel 211 to rotate forward. Conversely, applying the force in an opposite direction drives the ratchet wheel 211 to rotate in reverse, achieving bidirectional cyclic switching.

In other embodiments, the control assembly 21 can comprises a one-way ratchet (not shown in the figures), meaning the one-way ratchet has only a single set of ratchet teeth, thus allowing only unidirectional cyclic switching.

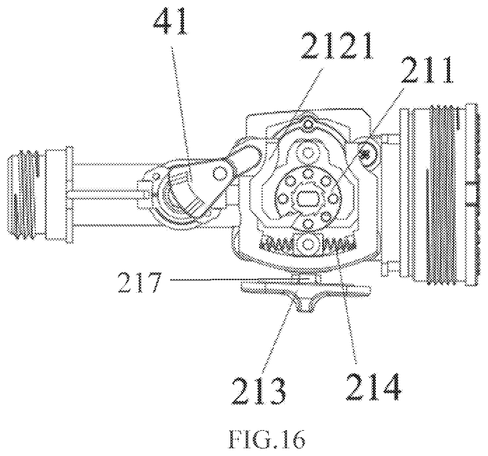

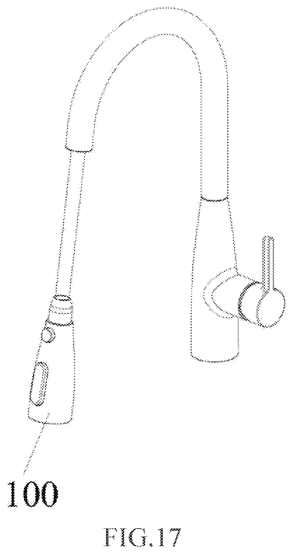

A second elastic member 214 is disposed between the pawl member 212 and the water channel body 1. This allows the two pawls 2121 to quickly reset relative to the water channel body 1 when the two pawls 2121 have rotated and the force is no longer applied to the water channel control button 213. This ensures a state of the pawl member 212 engaging with the ratchet wheel 211, guaranteeing stability after switching. It is understandable that a form of the water channel control button 213 is not specifically limited. In the current embodiment, the water channel control button 213 is disposed on the pawl member 212, so that the pawl member 212 can be pushed to rotate. As shown in FIG. 16, in other embodiments, the water channel control button 213 can be a push button. The water channel control button 213 is connected to the pawl member 212 through a connecting rod 217, and the connecting rod 217 is pivotally connected to the water channel body 1. Thus, horizontally pushing the water channel control button 213 drives the pawl member 212 to rotate. For example, the second elastic member 214 is a spring.

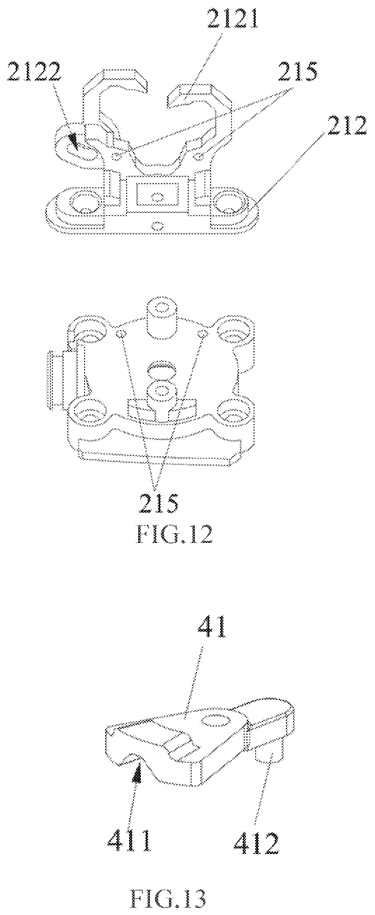

As shown in FIG. 12, in some embodiments, to ensure the stability of an engaging connection between the two pawls 2121 and the ratchet wheel 211 and to enable accurate resetting of the two pawls 2121 during a reset process of the two pawls 2121, magnetic members 215 are arranged on the two pawls 2121 and the water channel body 1. When the magnetic members 215 on the two pawl 2121 face the magnetic members 215 on the water channel body 1, the two pawl 2121 engage with the ratchet wheel 211, thereby ensuring accuracy of a reset position. In the current embodiment, the magnetic members 215 are magnets.

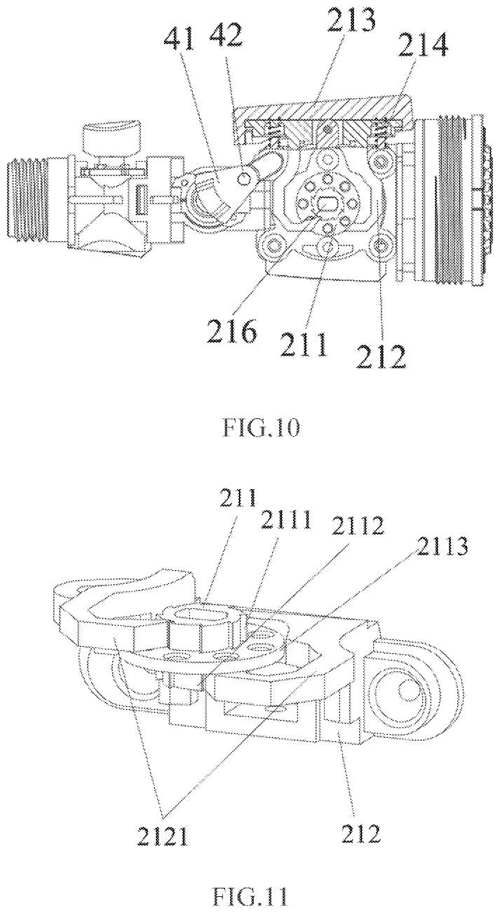

Furthermore, as shown in FIG. 11, to prevent the two pawls 2121 from undergoing unnecessary misalignment when the ratchet wheel 211 rotates, which may cause the two pawls 2121 to interfere by being misaligned with the first ratchet teeth 2111 and the second ratchet teeth 2112, in some embodiments, a partition wall 2113 is arranged on the ratchet wheel 211. The partition wall 2113 is arranged circumferentially along an outer periphery of the ratchet wheel 211, and the first ratchet teeth 2111 and the second ratchet teeth 2112 are located on two sides of the partition wall 2113. This can prevent misalignment interference of the two pawls 2121 and ensure the stability of the engaging connection.

As shown in FIGS. 3, 4, and 8, in some embodiments, when the ratchet wheel 211 drives the water distribution member 22 to rotate, to prevent water leakage during a rotation of the water distribution member 22, one or more water distribution sealing rings 23 are arranged around the inlet ports of the plurality of second water channels 12. The water distribution member 22 abuts the one or more water distribution sealing rings 23, thereby preventing water leakage. Furthermore, to ensure stability of the one or more water distribution sealing rings 23, a plurality of protruding platforms 14 are provided in the water distribution chamber 13. The one or more water distribution sealing rings 23 are sleeved onto the plurality of protruding platforms 14, and the inlet ports of the plurality of the second water channels 12 are located at top ends of the plurality of protruding platforms 14. Moreover, a first elastic member 24 is also disposed in the water distribution chamber 13. The first elastic member 24 is located on a side of the water distribution member 22 facing away from the one or more water distribution sealing rings 23. A first end of the first elastic member 24 is disposed on the water distribution member 22, and a second end of the first elastic member 24 is connected to the first rotating shaft 216, thereby enable the water distribution member 22 to tightly press the one or more water distribution sealing rings 23 through the first elastic member 24. Specifically, the first elastic member 24 is a spring. The water distribution member 22 comprises a first groove 222, and a bottom of the first groove 222 has an insertion post. The first end of the first elastic member 24 is sleeved onto the insertion post. An end portion of the first rotating shaft 216 comprises a second groove 223. The first rotating shaft 216 is inserted into the first groove 222, and the second end of the first elastic member 24 is fixed in the second groove 223. An outer wall of the first rotating shaft 216 and an inner wall of the first groove 222 each have a plurality of flat surfaces, forming a position-limiting connection to prevent idling.

As shown in FIGS. 3 and 5 to 7, in some embodiments, the upstream body 31 comprises a switching chamber 311. The water inlet port 312, the first upstream outlet port 313, and the second upstream outlet port 314 are all in communication with the switching chamber 311. The switching chamber 311 has a switching port 3111. In an extending direction of the switching chamber 311 (i.e., a direction from the switching port 3111 to a chamber bottom of the switching chamber 311), the first upstream outlet port 313 is closer to the switching port 3111 than the second upstream outlet port 314. That is to say, in the extending direction of the switching chamber 311, the first upstream outlet port 313 is located above the second upstream outlet port 314. This forms a water-passable flow channel from the water inlet port 312 through the switching chamber 311 to the first upstream outlet port 313, guiding the water flow to the water distribution port 221 in the water distribution chamber 13 (the switching assembly 32 is in the first state). Another water-passable flow channel is formed from the water inlet port 312 through the switching chamber 311 to the second upstream outlet port 314, guiding the water flow to the first water channel 11 (the switching assembly 32 is in the second state).

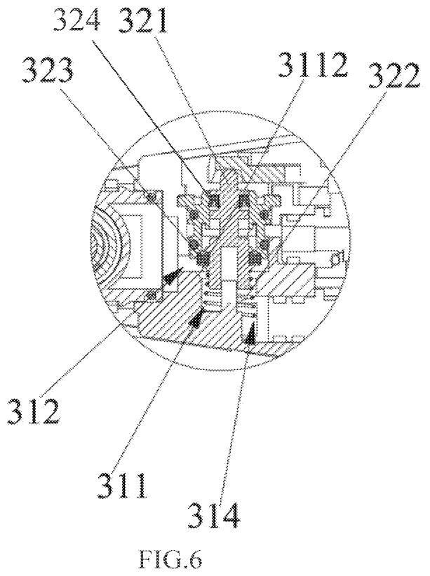

As shown in FIG. 6, the switching assembly 32 comprises a switching shaft 321 and a third elastic member 322. The switching shaft 321 is sealed into the switching chamber 311 through a switching sealing ring 324 at the switching port 3111 and can move in the switching chamber 311 along the extending direction of the switching chamber 311. The third elastic member 322 is disposed in the switching chamber 311. A first end of the third elastic member 322 is connected to the chamber bottom of the switching chamber 311, and a second end of the third elastic member 322 is connected to the switching shaft 321. The switching shaft 321 is disposed with a blocking member 323 circumferentially surrounding the switching shaft 321. For example, the blocking member 323 is a blocking ring. During movement, the switching shaft 321 drives the blocking member 323 to move, enabling the blocking member 323 to alternatively block one of the first upstream outlet port 313 or the second upstream outlet port 314.

In the current embodiment, the upstream body 31 has two inclined walls 3112 surrounding the switching chamber 311 and spaced apart from each other along the extending direction of the switching chamber 311. The two inclined walls 3112 are arranged opposite each other and are located between the first upstream outlet port 313 and the second upstream outlet port 314. A thickness of the blocking member 323 is less than a distance between the two inclined walls 3112. The blocking member 323 moves between the two inclined walls 3112 through the switching shaft 321. When the blocking member 323 abuts a first one of the two inclined walls 3112 adjacent to the switching port 3111, the water flow can pass through a gap between the blocking member 323 and a second one of the two inclined walls 3112 adjacent to a chamber bottom of the switching chamber 311 to be in communication with the second upstream outlet port 314, guiding the water flow to the first water channel 11 (the switching assembly 32 is in the second state). Similarly, when the blocking member 323 abuts the second one of the two inclined walls 3112 adjacent to the chamber bottom of the switching chamber 311, the water flow can pass through a gap between the blocking member 323 and the first one of the two inclined walls 3112 adjacent to the switching port 3111 of the switching chamber 311 to be in communication with the first upstream outlet port 313, guiding the water flow to the water distribution port 221 in the water distribution chamber 13 (the switching assembly 32 is in the first state). Since the switching shaft 321 is connected to the third elastic member 322, the third elastic member 322 enables the blocking member 323 to be maintained to abut the first one of the two inclined walls 3112 adjacent to the switching port 3111 of the switching chamber 311, thereby maintaining a state of blocking the first upstream outlet port 313.

When the third elastic member 322 is compressed by the switching shaft 321, causing the blocking member 323 to be in contact with the second one of the two inclined walls 3112 adjacent to the chamber bottom of the switching chamber 311, a restoring force generated by the third elastic member 322 is less than the water pressure. The water flow then switches from flowing to the second upstream outlet port 314 to flowing out through the first upstream outlet port 313. At this point, even without continuous manual external force pressing the switching shaft 321, the water pressure will continue to act on the blocking member 323, pressing the blocking member 323 against the third elastic member 322, thus keeping the blocking member 323 in the first state where water flows through the first upstream outlet port 313. Similarly, when the water is turned off and the water pressure is lost, even without external force, the third elastic member 322 can be reset to the second state in which the water distribution chamber 13 is in communication with the second upstream outlet port 314. That is, when the water is turned on again, the water flow will enter the first water channel 11 through the second upstream outlet port 314, forming the default initial water outlet state.

As shown in FIGS. 3 and 14 to 16, in some embodiments, for ease of control and to avoid overly complicated control logic, the circulating switchable shower head 100 further comprises a linkage mechanism 4. The linkage mechanism 4 is connected to the switching assembly 32 and the control assembly 21. When the switching assembly 32 is in the second state, the control assembly 21 drives the water distribution member 22 to rotate for water outlet mode switching. At this time, the linkage mechanism 4 can drive the switching assembly 32 to switch from the second state to the first state, allowing the water flow to enter the water distribution port 221. The water pressure enables the switching assembly 32 to be maintained in the first state. Driving the control assembly 21 again can switch the water distribution member 22 again for changing the water outlet modes. Therefore, by controlling the control assembly 21 of the water channel switching mechanism 2 and the linkage mechanism 4, the upstream switching mechanism 3 can be controlled, achieving simultaneous switching of water channels and the water outlet modes, which is convenient for operation.

Based on the above logic, in the current embodiment, the linkage mechanism 4 comprises a linkage body 41. A first end of the linkage body 41 is connected to the two pawls 2121. A second rotating shaft 42 is provided between the first end and a second end of the linkage body 41. The linkage body 41 is pivotally connected to the upstream body 31 or the water channel body 1 through the second rotating shaft 42. The second end of the linkage body 41 is located above the switching port 3111, and a surface of the second end of the linkage body 41 facing the switching port 3111 has a low point and a high point. In the second state, the switching shaft 321 abuts the low point. A rotation of the linkage body 41 causes the switching shaft 321 to alternatively correspond to the low point or the high point, thereby changing a length by which the switching shaft 321 extends out of or retracts into the switching port 3111, and consequently changing a position of the switching shaft 321. In the current embodiment, the surface of the second end of the linkage body 41 facing the switching port 3111 has an abutting groove 411. A bottom of the abutting groove 411 defines the low point, and an outer side of the abutting groove 411 is defined as the high point. When the switching shaft 321 abuts the bottom of the abutting groove 411, the water channel control button 213 drives the pawl member 212 to rotate bidirectionally. The pawl member 212 drives the linkage body 41 to rotate, thereby causing the second end of the linkage body 41 to rotate bidirectionally above the switching port 3111. This allows the switching shaft 321 to enter and exit the abutting groove 411 during a rotation of the abutting groove 411, changing a height at which the switching shaft 321 extends from the switching port 3111. As shown in FIGS. 12 and 13, illustratively, the pawl member 212 is provided with a swing groove 2122. The first end of the linkage body 41 is provided with a swing shaft 412, and the swing shaft 412 is inserted into the swing groove 2122. A groove wall of the swing groove 2122 abuts the swing shaft 412, thereby achieving a rotation of the linkage body 41.

In the second state, the switching shaft 321 abuts the bottom of the abutting groove 411. At this time, the switching shaft 321 does not compress the third elastic member 322, and the blocking member 323 blocks the first upstream outlet port 313. The water flow flows out through the second upstream outlet port 314. When the switching shaft 321 moves out of the abutting groove 411, the linkage body 41 abuts the switching shaft 321 to compress the third elastic member 322. The blocking member 323 blocks the second upstream outlet port 314, and the water flow flows out of the first upstream outlet port 313. Even at this point, releasing the water channel control button 213 to reset the two pawls 2121 and the linkage body 41 synchronously, the switching shaft 321 will not contact the bottom of the abutting groove 411 due to the water pressure. Only when the water pressure disappears will the switching shaft 321 reset and abut the bottom of the abutting groove 411. Thus, the water channel control button 213 can synchronously control the upstream switching mechanism 3 and the water channel switching mechanism 2, reducing control structures, simplifying control logic, and facilitating operation. The linkage mechanism 4 is hidden inside the housing 6, requiring only the water channel control button 213 from an external view, resulting in a clean and elegant appearance. Furthermore, to facilitate entry and exit of the switching shaft 321 into and from the abutting groove 411, a size of the abutting groove 411 gradually increases from a bottom of the abutting groove 411 to an opening of the abutting groove 411, meaning a groove wall of the abutting groove 411 is an inclined wall.

As shown in FIG. 3, in some embodiments, the linkage mechanism 4 can further comprise a position-limiting plate 43, and the position-limiting plate 43 is used to restrict axial movement of the linkage body 41. A form of the position-limiting plate 43 is not specifically limited. In the current embodiment, the position-limiting plate 43 is a cover plate, and the position-limiting plate 43 is placed above the linkage body 41. The cover plate may have a space groove to allow rotation of the position-limiting plate 43.

In other embodiments, the switching assembly 32 can further comprise an upstream control button (not shown in the figures). The upstream control button is used to control the switching assembly 32 from the second state to the first state. That is, when the switching assembly 32 of the circulating switchable shower head 100 is in the second state, the switching assembly 32 can be manually switched to the first state through the upstream control button, allowing the water flow to enter the water distribution port 221, and the water outlet mode can be then switched though the water channel control button 213.

In some embodiments, the circulating switchable shower head 100 is further provided with a water inlet joint 5, and the water inlet joint 5 is connected to the water inlet port 312. The water inlet joint 5 is disposed with a flow-increasing member 51 that can increase a water inlet flow rate. The flow-increasing member 51 is existing technology (refer to the description in patent CN103527815B, which is incorporated herein by reference) and will not be elaborated upon further.

As shown in FIG. 17, this application further provides a faucet, and the faucet comprises the circulating switchable shower head 100.

This application further provides a shower system, and the shower system comprises the circulating switchable shower head 100. Thus, the shower system ensures a fixed water output mode during initial use and allows for bidirectional circulating switching of the water outlet mode during operation. This simplifies the water outlet control circulation and enhances the user experience.

Evidently, the aforementioned embodiments of the present disclosure are merely examples provided to clearly illustrate the disclosure and are not intended to limit the implementation methods of the disclosure. For those of ordinary skill in the art, various obvious modifications, adjustments, and substitutions can be made without departing from the protective scope of the present disclosure. It is neither necessary nor possible to exhaustively list all implementation methods here. Any modifications, equivalent replacements, and improvements made within the spirit and principles of the present disclosure shall be included within the protective scope of the claims of the present disclosure.

What is claimed is:

1. A circulating switchable shower head, comprising:
a water channel body,
a water channel switching mechanism, and
an upstream switching mechanism, wherein:
the water channel body has a first water channel and a plurality of second water channels,
the water channel switching mechanism comprises a control assembly and a water distribution member,
the water distribution member comprises a water distribution port,
the water distribution member is disposed on the water channel body,
the control assembly is configured to drive the water distribution member to switch relative to the water channel body, so that the water distribution port is alternatively in communication with an inlet port of a selected one of the plurality of second water channels,
the upstream switching mechanism comprises an upstream body and a switching assembly,
the upstream body has a water inlet port as well as a first upstream outlet port and a second upstream outlet port which are in communication with the water inlet port,
the first upstream outlet port is in communication with the water distribution port,
the second upstream outlet port is in communication with an inlet port of the first water channel,
the switching assembly is disposed on the upstream body,
the switching assembly has a first state in which a water flow is enabled to pass through the first upstream outlet port and a second state in which the water flow is enabled to pass through the second upstream outlet port,
after the switching assembly is switched to the first state, the switching assembly is configured to be maintained in the first state due to water pressure, and
when the water pressure is lost, the switching assembly is switched from the first state to the second state.

2. The circulating switchable shower head according to claim 1, wherein:
the switching assembly comprises an upstream control button, and
the upstream control button is configured to control the switching assembly to be switched from the second state to the first state.

3. The circulating switchable shower head according to claim 1, comprising:
a linkage mechanism, wherein:
the linkage mechanism is connected to the switching assembly and the control assembly, and
when the control assembly drives the water distribution member to switch, the linkage mechanism is configured to drive the switching assembly to be switched from the second state to the first state.

4. The circulating switchable shower head according to claim 3, wherein:
the control assembly is configured to drive the water distribution member to be switched unidirectionally or bidirectionally in sequence relative to the water channel body, so that the water distribution port is alternatively in communication with the inlet port of the selected one of the plurality of second water channels in a unidirectional or bidirectional sequence.

5. The circulating switchable shower head according to claim 3, wherein:
the water channel body is provided with a water distribution chamber,
the water distribution chamber has a chamber inlet,
the first upstream outlet port is in communication with the water distribution chamber,
inlet ports of the plurality of second water channels are distributed circumferentially within the water distribution chamber,
the water distribution member is rotatably disposed in the water distribution chamber, and
the control assembly is configured to drive the water distribution member to rotate bidirectionally in the water distribution chamber.

6. The circulating switchable shower head according to claim 5, wherein:
one or more water distribution sealing rings are arranged around peripheries of the inlet ports of the plurality of second water channels, and
the water distribution member abuts the one or more water distribution sealing rings.

7. The circulating switchable shower head according to claim 6, wherein:
a first elastic member is further disposed in the water distribution chamber,
the first elastic member is located on a side of the water distribution member away from the one or more water distribution sealing rings, and
the first elastic member is configured to enable the water distribution member to have a tendency to press the one or more water distribution sealing rings.

8. The circulating switchable shower head according to claim 3, wherein:
the control assembly comprises a ratchet wheel, a pawl member, and a water channel control button,
the pawl member is pivotally connected to the water channel body,
the ratchet wheel is connected to the water distribution member through a first rotating shaft, and
the ratchet wheel is pivotally connected to the water channel body.

9. The circulating switchable shower head according to claim 8, wherein:
the ratchet wheel has first ratchet teeth and second ratchet teeth,
a tooth direction of the first ratchet teeth and a tooth direction of the second ratchet teeth are oriented in opposite directions,
the pawl member has two pawls opposing to each other,
the two pawls respectively engage with the first ratchet teeth and the second ratchet teeth,
the water channel control button is connected to the pawl member,
a force is configured to be applied to the water channel control button to enable one of the two pawls to be separated from the ratchet wheel while a second one of the two pawls pushes the ratchet wheel to rotate, and
a second elastic member is further disposed between the pawl member and the water channel body to reset the pawl member.

10. The circulating switchable shower head according to claim 9, wherein:
magnetic members are arranged on the two pawls and the water channel body, and
when the magnetic members on the two pawls face the magnetic members on the water channel body, the two pawls engage with the ratchet wheel.

11. The circulating switchable shower head according to claim 9, wherein:
a partition wall is arranged circumferentially along an outer periphery of the ratchet wheel, and
the first ratchet teeth and the second ratchet teeth are located on two sides of the partition wall.

12. The circulating switchable shower head according to claim 8, wherein:
the upstream body comprises a switching chamber,
the water inlet port, the first upstream outlet port, and the second upstream outlet port are all in communication with the switching chamber,
the switching chamber has a switching port,
the switching assembly comprises a switching shaft and a third elastic member,
a blocking member is disposed on the switching shaft,
the third elastic member is disposed in the switching chamber,
a first end of the switching shaft is connected to the third elastic member,
in the first state, the blocking member blocks the second upstream outlet port,
in the second state, the blocking member blocks the first upstream outlet port, and
the third elastic member is configured to enable the switching assembly to have a tendency to be maintained in the first state.

13. The circulating switchable shower head according to claim 12, wherein:
the linkage mechanism comprises a linkage body,
a first end of the linkage body is connected to the pawl member,
a second rotating shaft is disposed between the first end and a second end of the linkage body,
the linkage body is pivotally connected to the upstream body or the water channel body through the second rotating shaft,
the second end of the linkage body is located above the switching port,
a surface of the second end of the linkage body facing the switching port is provided with a low point and a high point,
in the second state, the switching shaft abuts the low point, and
the linkage body is configured to be rotated to drive the switching shaft to be switched to the low point or the high point.

14. The circulating switchable shower head according to claim 13, wherein:
the pawl member is provided with a swing groove,
the first end of the linkage body is provided with a swing shaft, and
the swing shaft is disposed in the swing groove, so that a groove wall of the swing groove abuts and drives the swing shaft to enable the linkage body to rotate.

15. The circulating switchable shower head according to claim 13, wherein:
the surface of the second end of the linkage body facing the switching port has an abutting groove,
a bottom of the abutting groove defines the low point, and
an outer side of the abutting groove is defined as the high point.

16. The circulating switchable shower head according to claim 15, wherein:
a size of the abutting groove gradually increases from the bottom of the abutting groove to an opening of the abutting groove.

17. The circulating switchable shower head according to claim 8, wherein:
the water channel control button is a pressing button or a pushing button.

18. The circulating switchable shower head according to claim 1, wherein:
the upstream body comprises a switching chamber,
the water inlet port, the first upstream outlet port, and the second upstream outlet port are all in communication with the switching chamber,
the switching chamber has a switching port,
the switching assembly comprises a switching shaft and a third elastic member,
a blocking member is disposed on the switching shaft,
the third elastic member is disposed in the switching chamber,
a first end of the switching shaft is connected to the third elastic member,
in the first state, the blocking member blocks the second upstream outlet port,
in the second state, the blocking member blocks the first upstream outlet port, and
the third elastic member is configured to enable the switching assembly to have a tendency to be maintained in the first state.

19. A faucet, comprising:
the circulating switchable shower head according to claim 1.

20. A shower system, comprising:
the circulating switchable shower head according to claim 1.
